(19) United States
(12) Patent Application Publication
(10) Pub. No.: US 2022/0405621 A1
(43) Pub. Date: Dec. 22, 2022

(54) CONTROLLING REACHABILITY IN A COLLABORATIVELY FILTERED RECOMMENDER

(71) Applicant: CANOPY CREST CORPORATION, Brooklyn, NY (US)

(72) Inventors: Sarah Ankaret Anderson Dean, Brooklyn, NY (US); Sarah J. Rich, Brooklyn, NY (US); Benjamin Recht, Brooklyn, NY (US)

(21) Appl. No.: 17/832,645

(22) Filed: Jun. 4, 2022

Related U.S. Application Data
(63) Continuation of application No. PCT/US20/63454, filed on Dec. 4, 2020.
(60) Provisional application No. 62/943,367, filed on Dec. 4, 2019.

(51) Int. Cl. G06N 5/04; G06K 9/62

(52) U.S. Cl. CPC G06N 5/04; G06K 9/6262; G06K 9/6239

(57) ABSTRACT

Recommender systems often rely on models which are trained to maximize accuracy in predicting user preferences. When the systems are deployed, these models determine the availability of content and information to different users. The gap between these objectives gives rise to a potential for unintended consequences, contributing to phenomena such as filter bubbles and polarization. An analysis of information availability through the lens of user recourse includes a computationally efficient audit for top-N matrix factorization recommender models and may be used for adapting recommender modules to meet targets for model performance parameters within defined contexts.

### PRIORITY CLAIM

The present application is a continuation of International Patent Application No. PCT/US20/63454, filed Dec. 4, 2020, which claims priority to U.S. Provisional Patent Application No. 62/943,367 filed Dec. 4, 2019, both of which are incorporated herein in their entirety by reference.

### FIELD

The present application relates to collaboratively filtered electronic recommender systems, and more particularly to methods, apparatus, and systems for evaluating and controlling reachability in recommender systems.

### BACKGROUND

Recommender systems, also referred to herein as recommenders and in singular as a recommender, are a class of machine learning algorithms and computing apparatus or systems using such algorithms that analyze user engagement with one or more computerized information resources, learn user interests and preferences by analyzing the engagement history, and provide recommendations to the user regarding information likely to be of interest.

Recommender systems often rely on models which are trained to maximize accuracy in predicting user preferences. When the systems are deployed, these models determine the availability of content and information to different users. The gap between these objectives gives rise to a potential for unintended consequences, contributing to phenomena such as filter bubbles and polarization. Thus, personalized curation becomes a potential mechanism for social segmentation and polarization, which apart from deleterious social effects, may also degrade the user experience of the recommender system. The exploited patterns across users may in fact encode undesirable biases which become self-reinforcing when used in feedback to make recommendations, and prevent the user from finding information the user is interested in.

Recommender models that incorporate user feedback for online updates adopt a computational perspective focusing on efficiency and speed of model updates. Statistical analysis is known for articulating sampling bias induced by recommendation, but does not correct the problem, while practical approaches identify ways to discard user interactions that are not informative for model updates. Others approaches focus on the learning problem, seeking to improve the predictive accuracy of models by exploiting the sequential nature of information. This includes strategies like Thompson sampling, upper confidence bound approximations, and reinforcement learning.

Much work on recommender systems focuses on the accuracy of the model, reflecting an implicit assumption that the primary information needs of users are described by predictive performance. Good predictive models, when used to moderate information, can unintentionally make portions of content libraries inaccessible to a majority of users. In addition, training sets can introduce de-personalized biases into recommender systems, for example, popularity bias causing popular content to be more frequently recommended regardless of individual interest.

Recommender systems influence the way information is presented to individuals for a wide variety of domains including music, videos, dating, shopping, and advertising. On one hand, the near ubiquitous practice of filtering content by predicted preferences makes the digital information overload possible for individuals to consume. By exploiting the patterns in ratings or consumption across users, preference predictions are useful in surfacing relevant and interesting content. On the other hand, this personalized curation is a potential mechanism for social segmentation and polarization. The exploited patterns across users may in fact encode undesirable biases which become self-reinforcing when used in feedback to make recommendations.

Alternative measures proposed in the literature include concepts related to diversity or novelty of recommendations. Directly incorporating diversity and novelty objectives into a recommender system might include further predictive models of users, e.g. to determine whether they are “challenge averse” or “diversity seeking”.

It would be desirable, therefore, to develop new methods and other new technologies for evaluating recommender systems and related methods or apparatus, that overcomes these and other limitations of the prior art.

### SUMMARY

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

The methods, apparatus and system disclosed herein are based more directly on agency and possibilities rather than predictive models and likelihood, through the lens of the agency of individuals. An underlying inspiration is to provide actionable recourse for binary decisions, where users seek to change negative classification through modifications to their features. For example, connections to concepts in explainability and transparency can be via the idea of counterfactual explanations, which provide statements of the form: if a user had features X, then they would have been assigned alternate outcome Y. This approach is related to strategic manipulation, which studies nearly the same problem with the goal of creating a decision system that is robust to malicious changes in features.

Recent empirical work shows that personalization on the Internet has a limited effect on political polarization, and in fact it can increase the diversity of content consumed by individuals. However, these observations follow by comparison to non-personalized defaults of cable news or well-known publishers. In a digital world where all content is algorithmically sorted by default, how do we articulate the tradeoffs involved? YouTube has recently come under fire for promoting disturbing children's content and working as an engine of radicalization. This comes as views of recommended videos approach 1 billion hours of watch time per day; over 70% of views now come from the recommended videos. This case is an illustrative example of potential pitfalls when putting large scale machine learning-based systems in feedback with people and highlights the importance of creating analytical tools to anticipate and prevent undesirable behavior. Such tools should seek to quantify the degree to which a recommender system will meet the information needs of its users or of society as a whole, where these “information needs” must be carefully defined to include goals like relevance, coverage, and diversity.

An important aspect of improving recommender systems involves the empirical evaluation of these metrics by simulating recommendations made by models once they are trained. To understand at a more fundamental level the mechanisms that lead to different behaviors for learned models, a complementary approach based on a direct analysis of the model and user behavior may be used. Drawing conclusions about the likely behavior of recommendation models involves treating humans as a component within the system, and the validity of the conclusions hinges on modeling human behavior.

The present application discloses an evaluation method that favors the agency of individuals over the limited perspective offered by behavioral predictions. Its focus is on questions of possibility: to what extent can someone be pigeonholed by their viewing history? What videos may they never see, even after a drastic change in viewing behavior? And how might a recommender system fail by encoding biases in a way that limits the available library of content, in effect?

This perspective brings user agency into the center, prioritizing the ability for models to be as adaptable as they are accurate, able to accommodate arbitrary changes in the interests of individuals. User studies find positive effects of allowing users to exert greater control in recommendation systems. While there are many system-level or post-hoc approaches to incorporating user feedback, the present application focuses directly on the machine learning model that powers recommendations.

Applying these ideas to recommender systems is complex because while they can be viewed as classifiers or decision systems, there are as many outcomes as pieces of content. Computing precise action sets for recourse for every user-item pair is unrealistic, because most users will not become aware of most items returned by a recommender system.

Broadly speaking, auditing recommender systems with learning-based components should directly consider the models' behavior when put into feedback with humans. Many novel approximations and strategies for large scale machine learning recommender systems are possible.

The present application discloses an algorithm for defining user recourse and item availability for recommender systems. This perspective extends the notion of recourse to multiclass classification settings and enables specialization for concerns most relevant for information retrieval systems. The analysis herein focuses on top ‘N’ recommendations made using matrix factorization models. Properties of latent user and item representations are shown to interact to limit or ensure recourse and availability. This insight yields a novel perspective on user cold-start problems, where a user with no rating history is introduced to a system. In addition, a computationally efficient model is proposed for auditing/evaluating recommender systems, The proposed analysis can be used as a tool to interpret how learned models will interact with users when deployed.

In an aspect of the disclosure, a method for providing a user interface of a computing device enabling selection of and access to items of electronic content in an online library may include evaluating one or more performance parameters of a recommender module that provides top-N recommendations based on user factors and content factors for an online library. The detailed description describes several examples of evaluation algorithms and related operations.

In other, optional aspects, the method may include comparing the one or more performance parameters to a performance metric and revising the recommender module based on the comparing, preparing a revised recommender module. Further, the method may also include generating top-N recommendations using the revised recommender module and sending the top-N recommendations to a client device for output to a user.

As used herein, a “client device” includes at least a computer processor coupled to a memory and to one or more ports, including at least one input port and at least one output port (e.g., a desktop computer, laptop computer, tablet computer, smartphone, PDA, etc.). A computer processor may include, for example, a microprocessor, microcontroller, system on a chip, or other processing circuit. As used herein, a “processor” means a computer processor.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the examples may be employed. Other advantages and novel features will become apparent from the following detailed description when considered in conjunction with the drawings and the disclosed examples, which encompass all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify like elements correspondingly throughout the specification and drawings.

FIG. 1 is a schematic diagram illustrating a recommender system communicatively coupled to client devices providing recommendations at least one user.

FIG. 2 is a concept diagram illustrating and example of recommender data flow.

FIG. 3 is a block diagram illustrating elements of a recommender system.

FIG. 4 is a flow diagram illustrating elements of evaluating (auditing) and revising a recommender system used for generating top-N recommendations.

FIGS. 5A-5B are diagrams illustrating a latent space containing factors used in a matrix factorization recommender model for predicting user ratings for items of content.

FIG. 6 is a table chart illustrating an example of an algorithm for an item-based model audit.

FIG. 7 is a chart showing a results of a test RMSE of matrix factorization models on a test dataset.

FIG. 8 is a chart showing a total number of aligned-reachable movies for various parameters N.

FIGS. 9A-9B are charts comparing the distributions of the available and unavailable items for N=5 in an example training set.

FIGS. 10A-10B show relationships between lengths of user history for several different latent dimensions of a training set.

FIGS. 11, 12A and 12B are charts comparing recourse for two different types of new items of a training set.

FIG. 13 is a chart comparing difficulty of recourse via reaction for two types of new items of a training set.

FIG. 14 is a flow chart illustrating further aspects of testing and revising a recommender module.

FIGS. 15-16 are flow charts illustrating additional operations that may be used with the methods of FIG. 4 or 14.

FIG. 17 is a conceptual block diagram illustrating components of an apparatus or system for evaluating (auditing) and revising a recommender system used for generating top-N recommendations.

### DETAILED DESCRIPTION

Various aspects are now described with reference to the drawings. In the following description, for purposes of explanation, numerous specific details are set forth to provide a thorough understanding of one or more aspects. It may be evident, however, that the various aspects may be practiced without these specific details. In other instances, well-known structures and devices are represented in block diagram form to facilitate focus on novel aspects of the present disclosure.

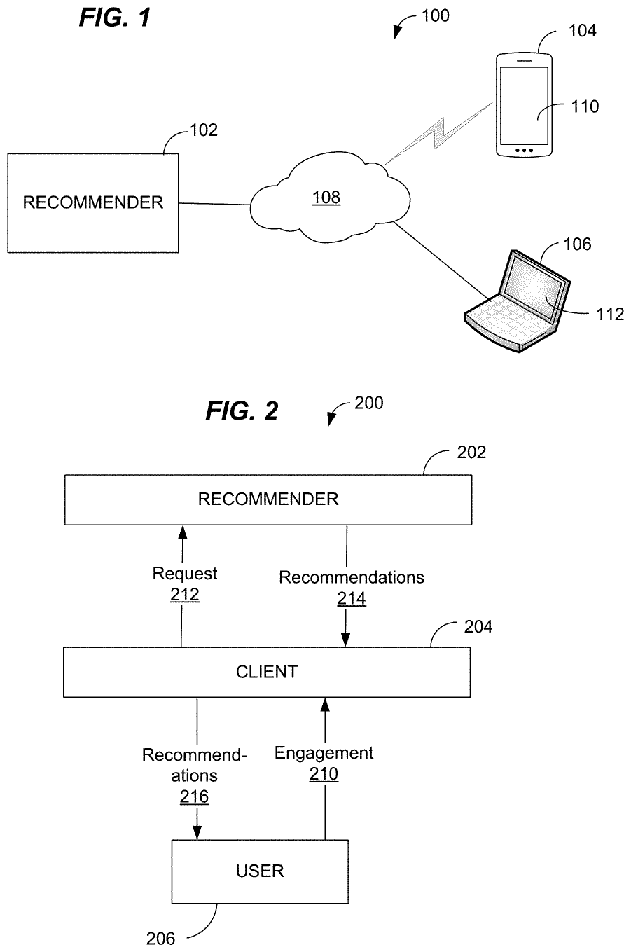

Referring to FIGS. 1 and 2, the present example concerns an item-based recommender module 102, 202 that functions to provide users who each operating a client device (e.g., a smart phone 104 or personal computer 106) with recommended items based on items with which they have previously engaged, The recommender module 102, 202 may include at least one processor operating a recommender algorithm based on user factors and content factors for an online content library. Each client device 104, 106 may communicate with the recommender 102, 202 via one or more communication and/or computer networks 108, for example, a wide area network, cellular telephony network, or satellite communications network. The recommender may be implemented in any suitable server, for example a stand-alone server, server array, cloud server or distributed server. Results from the recommender may be provided to the client device 104, 106 or to a server 102. If to the client device 104, 106, the client device may generate a display of the recommendations for output to a user interface device, for example a display screen 110, 112. Such display may include on or more objects (e.g., links) operative for retrieving and user-selected ones of the content items recommended by the recommender. Accordingly, methods for evaluating and adapting a recommender module are part of an information system in which a user operating a client device selects and accesses electronic content in a remote library via a user interface, including but not limited to providing the user interface.

Prior to serving users, the recommender is trained with access to a training set representing ‘n’ users and ‘m’ items until ready to serve recommendations. As used herein, a “request” from a client to the recommender is configured to enable the person using the recommender to obtain new recommendations. Features of a client device executing a recommendation process for the user may include access to the user's engagement history in a computer memory and a function for identifying relevant recommendations and showing them to the user.

FIG. 2 represents an overview of recommendation data flow 200. The client device 204 generates engagement data 210 based on user 206 interactions with a content library or database. Then, the client 204 generates a request 214 that it sends to the recommender 202. The request 214 r ∈ [0,1]ⁿ may be, or may include, a binary, typically sparse, vector in item-space. Each entry in the vector may represent a user's engagement with one item, and nonzero values may represent engagement beyond a certain threshold deemed appropriate for the setting. In embodiments of the systems 100, 200, for each new request from a client, the centralized recommendation server 102, 202 sees only a list of items and receives no identifying information from the client such as a user identifier (ID), device ID, Internet Protocol (IP) address, or other identifier from which the user may be identified.

In embodiments, a request round may include a series of recursive information exchanges between the client and the recommender. In each recommendation round, the client 204 assembles a list of items (the request 212) to send to the recommender, and the recommender 202 returns a list of items (the recommendations 214) based on the items it received from the client. For embodiments wherein the recommender is strictly item-based, each recommendation returned by the recommender, may include 3 parts: (1) the recommended item; (2) the associated item from the original request; and (3) a scaled weight w ∈ [0,1], wherein w measures the “closeness” of the recommended item to the associated item, i.e., similarity.

In one request round, the recommender returns an equal number of items for each item in the original request, Note that items may be recommended multiple times in the list of recommendations returned by the recommender, as they may be dose to one or more different associated items from the original request. This framework should be sufficiently general to extend to a range of item-based recommender implementations.

It may be assumed that the recommender is making recommendations based on some measure of similarity between two items, and that this similarity measure can be computed for any two items in the recommender's corpus. Any suitable similarity measure as known in the art (e.g., Euclidian distance, cosine distance, Jaccard distance, Pearson correlation distance) or that may be developed may be used by a recommender. Evaluation is agnostic with respect to the similarity measure used by the recommender, but evaluation metrics such as recourse or availability may differ in results depending on the evaluation method used.

Problem Setting. A recommender system considers a population of users and a collection of items. A “rating” by user u of item r is denoted as rᵤᵢ ∈ [symbol] ⊆ [symbol] . This value can be either explicit (e.g. star-ratings for movies) or implicit (e.g. number of listens). As used herein, n denotes the number of users in the system and m denotes the number of items in the relevant content library. As used herein, Ωᵤ denotes the set of items whose ratings by user u have been observed. We collect these observed ratings into a sparse vector rᵤ ∈ [symbol] ^{m} whose values are defined at Ωᵤ and 0 elsewhere. Then a system makes recommendations with a policy π(rᵤ) which returns a subset of items. Although the present example focuses on deterministic policies, the analyses can be extended to randomized policies which sample from a subset of items based on their ratings. It is only necessary to define reachability with respect to probabilities of seeing an item, and then to carry through terms related to the sampling distribution.

To define the reachability sub-problem for a recommender system, assume a user u can reach item I if there is some allowable modification to their history rᵤ that causes item i to be recommended. The reachability problem for user u and item i is defined as

$${minimize}_{r ∈ ℳ ( {r}_{u} )} cost ( r ; {r}_{u} ) subject to i ∈ π ( r ) \qquad ( 1 )$$

where the modification set [symbol] (rᵤ) ⊆ [symbol] describes how users are allowed to modify their rating history and cost(r, rᵤ) describes how “difficult” or “unlikely” it is for a user to make this change. This notion of difficulty might relate discretely to the total number of changes, or to the amount that these changes deviate from the existing preferences of the user. By defining the cost with respect to user behavior, the reachability problem encodes both the possibilities of recommendations through its feasibility, as well as the relative likelihood of different outcomes as modeled by the cost.

The ways that users can change their rating histories, described by the modification set [symbol] (rᵤ) depends on the design of user input to the system. For example, embodiments may include a single round of user reactions to N recommendations and use two models of user behavior: changes to existing ratings, refer to herein as “history edits”; and reaction to the next batch of recommended items, which we referred to herein as “reactions.” In the first case, [symbol] (rᵤ) consists of all possible ratings on the support Ωᵤ. In the second case, [symbol] (rᵤ) consists of all new ratings on the support π(rᵤ) combined with the existing rating history.

The reachability problem defines a quantity for each user and item in the system. To use this problem as a metric for evaluating recommender systems, we consider both user- and item-centric perspectives. For users, this is a notion of recourse. As used herein, the amount of recourse available to a user u is defined as the percentage of unseen items that are reachable, i.e. for which discovery is feasible. The difficulty of recourse is defined by the average value of the recourse problem over all reachable items i.

In comparison, the item-centric perspective centers around availability. As used herein, the availability of items in a recommender system is defined as the percentage of items that are reachable by some user.

These definitions are useful for evaluating and providing fair representation of content within recommender systems. This is significant for users—for example, to what extent have their previously expressed preferences limited the content that is currently reachable? It is also important to content creators, for whom the ability to build an audience depends on the availability of their content in the recommender system overall.

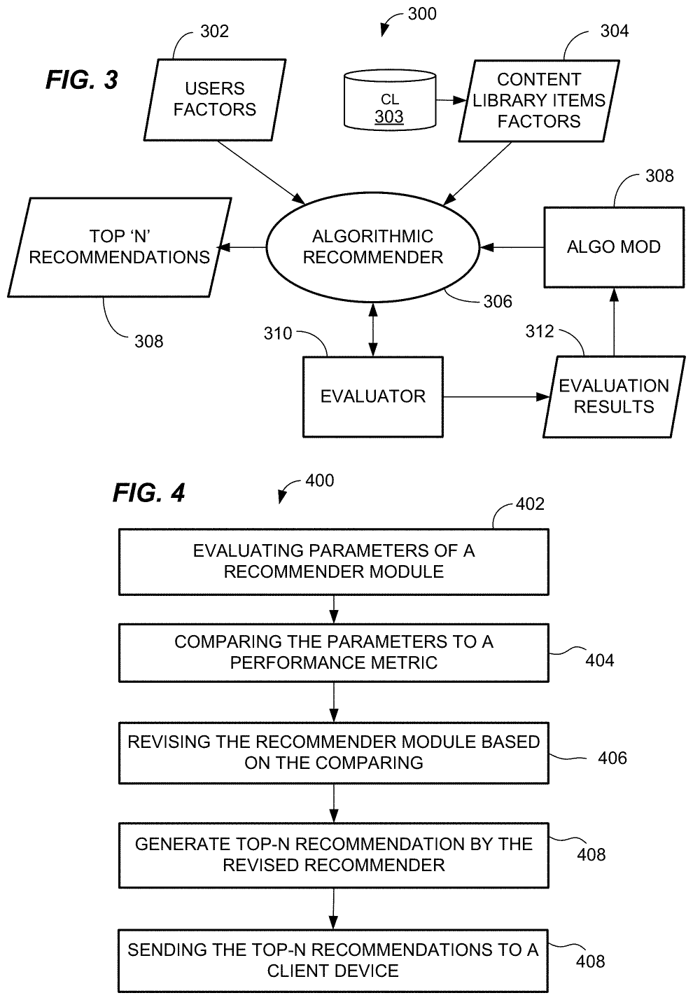

Referring to FIG. 3, a system 300 includes an algorithmic recommender module 306 running an algorithm (e.g., matrix factorization) that provides top-N recommendations 308 in response to requests (implicit or explicit) from users, based on users' factors 302 and items factors 304. Modules of the system 300 may comprise hardware, firmware or software implemented in one or more computers. Each user is associated with one or more factors based on information known about the user, including but not limited to user preferences, which may be indicated implicitly (e.g., by the user's past selections and use of content items) or explicitly (e.g., by user-supplied ratings). Each content item in the content library 303 is associated with one or more factors indicating an aspect of the content items. The top-N recommendation identifies ‘N’ number of content items for the user.

An evaluator module 310 evaluates performance attributes, for example, recourse and availability, for the algorithmic recommender 306, outputting values of the performance attributes as results 312 as machine-readable data in a computer memory. The module 308 may receive the evaluation results 312 for comparing to at least one targeted performance value and adjust parameters of the recommender algorithm so that the recommender achieves the at least one targeted value.

FIG. 4 shows elements of a method 400 for providing a user interface of a computing device enabling selection of and access to items of electronic content in an online library. The method 400 may include evaluating 402, by at least one processor, one or more performance parameters of a recommender module that provides top-N recommendations based on user factors and content factors for an online library, In an aspect, the parameters include item availability and user recourse, or related factors.

The method 400 may further include comparing 404, by the at least one processor, the one or more performance parameters to a performance metric. The performance metric may be, for example, a target minimum for recourse and/or availability.

The method 400 may further include revising 406, by the at least one processor, the recommender module based on the comparing. For example, the processor may increase or decrease a number of dimensions used by the recommender module, revise a training set, or other parameters as described in the description below that are determinative of the targeted metrics.

The method 400 may further include generating 408, by the at least one processor, top-N recommendations using the recommender module as revised by the revising. For example, the processor may receive a request for a recommendation from a client device, and generate top-N recommendations based on user and item factors for the target library. The method 400 may further include sending 408, by the at least one processor, the top-N recommendations to a client device for output to a user.

A more detailed description of algorithms and methods relevant to evaluation by the evaluator 310 and other aspects of the system 300 and method 400 follows.

Matrix Factorization Models. While many different approaches to recommender systems exist, ranging from classical neighborhood models to more recent deep neural networks, the examples herein focus on, but are not limited to, matrix factorization models. Due to its power and simplicity, the matrix factorization approach is still widely used and capable for many applications.

A matrix factorization recommender model may predict each user rating for an item of content as the dot product between a user factor ‘P’ and an item factor ‘q’: \hat{r}ᵤᵢ=Pᵤ^{T}qᵢ. These factors he in a latent space of specified dimension d which controls the complexity of the model. The factors can be collected into matrices P ∈ R^{n×d} and Q ∈ R^{m×d}. Fitting the model may entail solving the nonconvex minimization:

$${minimize}_{P , Q} {\sum }_{u} {\sum }_{i ∈ {Ω}_{u}} {( {r}_{ui} - {P}_{u}^{T} {q}_{i} )}^{2} + Γ ( P , Q ) \qquad ( 1 )$$

wherein Γ regularizes the factors (P,Q).

The predicted ratings of unseen items are used to make recommendations. Specifically, we consider top-N recommenders which return {i: \hat{r}ᵤᵢ>\hat{r}ᵤⱼ all but at most N unseen items j}. Recalling that predicted ratings are the inner product of latent factors, the condition \hat{r}ᵤᵢ>\hat{r}ᵤⱼ reduces to a linear inequality on the latent space, with

qᵢ^{T}Pᵤ>qⱼ^{T}Pᵤ⇔(qᵢ−qⱼ)^{t}Pᵤ>0.

Thus, for fixed item factors, a user's recommendations are determined by their latent representation along with a list of unseen items. As used herein, the recommender policy is denoted as π(p; Ω) instead of π(r). As shown in following sections, the relationships of factors in this latent space mediate the availability of items to users.

When the ratings of users change, their latent representation should change as well. While there are a variety of possible strategies for performing online updates, we focus on the least squares approach, where

$${P}_{u} = {arg}_{p}^{min} {‖ {r}_{u , {Ω}_{u}} - {Q}_{{Ω}_{u}} p ‖}_{2}^{2} + {Γ}_{u} ( p ) .$$

This is similar to continuing an alternating least-squares (ALS) minimization. When analyzing single round of recommendations, simultaneous updates to the item factors in Q need not be considered.

Matrix factorization models such as these encompass a wide range of strategies which specialize to different assumptions about underlying data and user behavior. This includes methods based on sparsity like SLIM, which performs well on implicit ratings, and constrained approaches like non-negative matrix factorization. Furthermore, many augmentations can be made to the basic model, like the inclusion of implicit information about preferences or bias terms.

In the following, the canonical case of [symbol] ₂ regularization on user and itern factors, with Γᵤ(x)=Γᵢ(x)=λ∥x∥₂², is focused on. In this case, the user factor calculation is given by:

pᵤ=(Q_{Ω}_{ᵤ}^{T}Q_{Ω}_{ᵤ}+λI)⁻¹Q^{T}rᵤ. (3)

Although the present application focuses on the simple case exemplified by Equation (3), results herein can be extended to cases in which bias terms are incorporated into predictions, sometimes referred to as SVD+.

Recourse and Availability. The reachability problem may be reformulated to the case of recommendations made by matrix factorization models. For example, by assuming the simplifying case that N=1 and making direct connections between model factors and the recourse and availability provided by the recommender system.

First, for an item i to be recommended for top-1, the constraint i ∈ π(p, Ω) is equivalent to requiring that

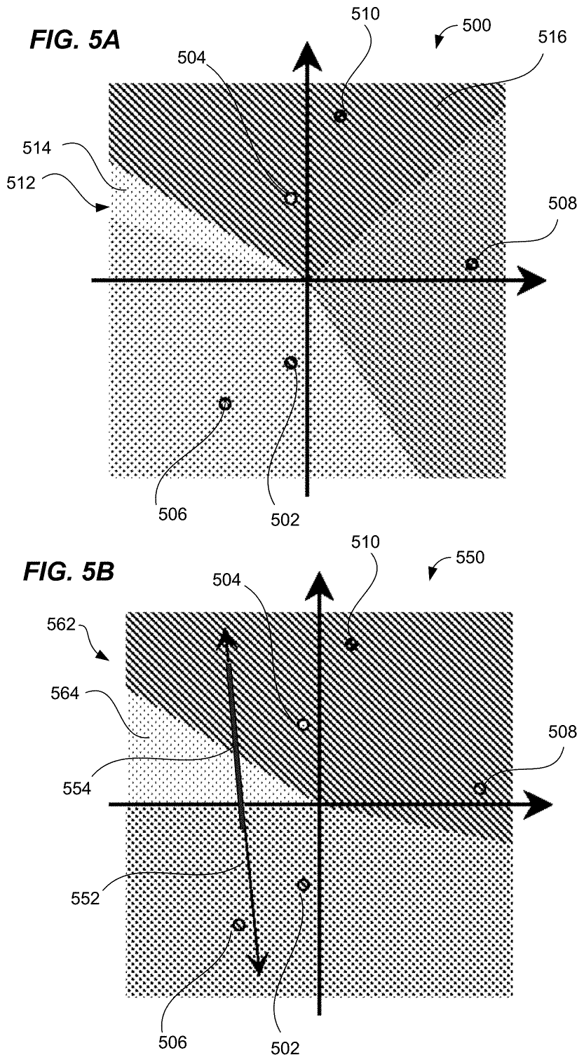

(qᵢ−qⱼ)^{T}p>0∀j ∉Ω⇔Gᵢp>0.

where Gᵢ is defined to be a m−|Ω|×d matrix with rows given by (qᵢ−qⱼ) for j ∉ Ω. This is a linear constraint on the user factor p, and the set of user factors which satisfy this constraint make up an open convex polytopic cone, This set may be referred to as the item-region for item since any user whose latent representation falls within this region will be recommended item i. The top-1 regions partition the latent space 500, as illustrated by FIG. 5A for a toy example with latent dimension d=2. Item factors are indicated by points 502-510 as examples of content items. In both FIGS. 5A & 5B, the top-1 regions 512 are indicated by different levels of shading. One item 502 is unavailable, and another item 504 is reachable, but not aligned-reachable. In FIG. 5B showing another example of a latent space 550 with regions 562 indicated by different levels of shading, wherein the availability of items 502-510 changes for a user who has seen the items 504, 506 with each item's rating fixed. The double-arrowed line 552 indicates how the user's representation can change depending on their rating of the item 506. The bolded portion 554 of line 552 indicates the constraining effect of requiring bounded and integer-valued ratings, which affect the reachability of the lightly-shaded region 564.

Item factors define regions within the latent space, while user factors may be represented as points that can move between regions. The constraints on user actions are described by the modification set [symbol] (rᵤ). We will distinguish between mutable and immutable ratings of items within a rating vector rᵤ. Let 0 denote the set of items with immutable ratings and let r₀ ∈ [symbol] ^{|Ω}^{₀}^{|} denote the corresponding ratings. Then let denote the set of items with mutable ratings. In what follows, the full set of observed ratings is written as Ω=Ω₀ ∪ Ωₘ. The modification set is given by all rating vectors r ∈ [symbol] with: (1) fixed immutable ratings r_{Ω}_{₀}=r₀; (2) mutable ratings r_{Ω}_{ₘ}=a for some value a ∈ [symbol] ^{|Ω}^{ₘ}^{|}; and (3) unseen items with no rating, r_{Ω}_{^{⊂}}=0. The variable a is the decision variable in the reachability problem.

Then a user's latent factor can change as

p=(Q_{Ω}^{T}Q_{Ω}+λI)⁻¹(Q_{Ω}_{₀}^{T}r₀+Q_{Ω}_{ₘ}^{T}a)=v₀+Ba

wherein

W=(Q_{Ω}^{T}Q_{Ω}+λI)⁻¹, B=QW_{Ω}_{ₘ}^{T}, v₀z=WQ_{Ω}_{₎}^{T}r₀.

It is thus clear that this latent factor lies in an affine subspace. This space is anchored at v₀ by the immutable ratings, while the mutable ratings determine the directions of possible movement. This idea is illustrated in FIG. 5B, which further demonstrates the limitations due to bounded or discrete ratings, as encoded in the rating set [symbol] .

Accordingly, the reachability problem for matrix factorization models may be specialized as:

$${minimize}_{a ∈ {ℛ}^{\vert {Ω}_{m} \vert}} cost ( [ {r}_{0} ; a ] ; {r}_{u} ) subject to {G}_{i} ( {v}_{0} + Ba ) > 0 \qquad ( 4 )$$

If the cost is a convex function and [symbol] is a convex set, this is a convex optimization problem which can be solved efficiently. If [symbol] is a discrete set or if the cost function incorporates nonconvex phenomena like sparsity, then this problem can be formulated as a mixed-integer program (MIP). Despite bad worst-case complexity, MIP can generally be solved quickly with modern software.

Item Availability. Beyond defining the reachability problem, deriving properties of recommender systems based on their underlying preference models is of interest. First, consider the feasibility of Equation (4) with respect to its linear inequality constraints, for example, focusing on the item-regions and ignoring the effects of user history Ω, anchor point v₀, and control matrix B. The “convex hull” of unseen item factors, which is the smallest convex set that contains the item factors can be determined by:

conv({qⱼ}ⱼ)={Σⱼλⱼqⱼ: Σⱼλⱼ≤1 and λ≥0}.

Methods and systems herein may also make use of “vertices” of the convex hull. Such vertices are item factors that are not contained in the convex hull of other factors, e.g., qᵢ ∉ conv({qᵢ}_{j≠i}). Examples are provided below.

Example Result 1: In a top-1 recommender system, the available items are those whose factors are vertices on the convex hull of all item factors. As a result, the availability of items in a top-1 recommender system is determined by the way the item factors are distributed in space: it is simply the percentage of item factors that are vertices of their convex hull. A proof is provided, along with proofs of all results to follow, in the paper by the inventors hereof, “Recommendations and User Agency: The Reachability of Collaboratively-Filtered Information,” December 2019, arXiv:1912.10068v1 (hereinafter, “Reachability Paper”), which is incorporated herein in its entirety by reference.

We can further understand the effect of limited user movement in the case that ratings are real-valued, i.e. [symbol] = [symbol] . In this case, we consider both anchor point v₀ and control matrix B. For a fixed this anchor point determines the set of items j necessary for comparison: qⱼv₀≥qᵢv₀, i.e. those that are more similar to the anchor point than item i is. Items satisfying this expression are referred to herein as the “anchor-similar items.”

Example Result 2: multiplication of item factors by the transpose of the control matrix, referred to herein as the “multiplied factors” (B^{T}qᵢ), can also be considered. In a top-1 recommender system, a user can reach any item whose multiplied factor is a vertex of the convex hull of all unseen anchor-similar multiplied item factors. Furthermore, if the factors of the items with mutable ratings are full rank, i.e. Q_{Ω}_{ₘ} has rank equal to the latent dimension of the model d, then item availability implies user recourse. It follows that for a model with 100% item availability, having as many mutable ratings as latent dimensions is sufficient for ensuring that users have full recourse, so long as the associated item factors are linearly independent. This observation highlights that increased model complexity calls for more comprehensive user controls to maintain the same level of recourse.

This conclusion follows only from considering the possibilities of user action. To consider likelihood for various outcomes, the cost of user action should be accounted for.

Bound on Difficulty of Recourse. Cost of user action can be modeled as a penalty on change from existing ratings and used to show a bound on the difficulty of recourse for users. For items whose ratings have not already been observed, the change from predicted ratings may be penalized instead of change from actual ratings. For simplicity, this penalty may be represented as the norm of the difference.

For history edits, all mutable items have been observed, so the cost function is

costₕᵢₛₜ(r; rᵤ)=∥r−rᵤ∥.

Additionally, all existing ratings are mutable so mutable set Ωₘ=Ωᵤ and immutable set Ω₀=0. For reactions, the ratings for the new recommended items have not been observed, so

Cost_{react}(r; rᵤ)=∥r_{π(r}₎−\hat{r}_{π(r}_{ᵤ}₎∥.

Additionally, the rating history is immutable Ωₘ=Ωᵤ, while the mutable ratings are the recommendations with Ωₘ=π(rᵤ). Under this model, an upper bound on the difficulty of recourse can be compute. This result holds for the case that ratings are real-valued, i.e. [symbol] = [symbol] and that the reachable items satisfy an alignment condition as defined in (8) of the Reachability Paper.

Example Result 3: Let pᵤ indicate the user's latent factor per Eq. (3) before any actions are taken or the next set of recommendations are added to the user history. Then both in the case of full history edits and reactions,

$$difficulty of recourse for user u \leq ‖ {B}^{†} ‖ \cdot \frac{1}{\vert {Ω}_{r} \vert} {\sum }_{i ∈ {Ω}_{r}} ‖ {q}_{i} - {p}_{u} ‖ ,$$

where Ωᵣ ⊆ Ω^{⊂} is the set of reachable items.

This bound depends how far item factors are from the initial latent representation of the user. When latent representations are close together, recourse is easier or more likely—an intuitive relationship. This quantity will be large in situations where a user is in an isolated niche, far from most of the items in latent space. The bound also depends on the conditioning of the user control matrix B, which is related to the similarity between mutable items: the right hand side of the bound will be larger for sets of mutable items that are more similar to each other.

User Cold Start. The amount and difficulty of recourse for a user yields a novel perspective on how to incorporate new users into a recommender system. The user cold-start problem is the challenge of selecting items to show a user who enters a system with no rating history from which to predict their preferences. This is a major issue with collaboratively filtered recommendations. Recommender systems may often rely on incorporating extraneous information to the new user. These strategies focus on presenting items which are most likely to be rated highly or to be most informative about user preferences.

The idea of recourse offers an alternative point of view. Rather than evaluating a potential “onboarding set” only for its contribution to model accuracy, a processor can choose a set which additionally ensures some amount of recourse. Looking to Example Result 2, we can evaluate an onboarding set by the geometry of the multiplied factors in latent space. In the case of onboarding, v₀=0 and B=WQ_{Ω}, so the recourse evaluation involves considering the vertices of the convex hull of the columns of the matrix {Q_{Ω}WQ_{Ω}_{^{⊂}}}.

An additional perspective is offered by considering the difficulty of recourse. In this case, a processor may make use of ∥B^{†}∥. If we consider an [symbol] ₂ norm, then recourse evaluation reduces to

$$‖ {B}^{†} ‖ = {max}_{i} \frac{{σ}_{i}^{2} + λ}{{σ}_{i}}$$

where σ₁≥σ₂≥ . . . ≥σᵣ>0 are the nonzero singular values of Q_{Ω}. Minimizing this quantity is hard. Due to computational challenges, these metrics may primarily be used to distinguish between candidate onboarding sets, based on the ways these sets provide user control. In addition, or in an alternative, a processor may generate candidate sets based on these recourse properties.

Sufficient Conditions for Top-N. In the previous section, a characterization of reachability for top-1 recommender systems is developed for evaluating or generating candidate cold-start sets. However, most real-world applications involve serving several items at once. Furthermore, using N>1 can approximate the availability of items to a user over time, as they see more items and increase the size of the set that is excluded from the selection. In the instant section, sufficient conditions for developing a computationally efficient model audit that provides lower bounds on the availability of items in a model are outlined. A processor may run the audit algorithmically to evaluate this availability. In addition, this section provides approximations for computing a lower bound on the recourse available to users, which may similarly be executed by a processor for evaluation and generation purposes.

An item-region for the top-N case may be defined, conditioned on i ∈ π(p; Ω) for any user factors in the set

[symbol]

ᵢ={p:(qᵢ−qⱼ)^{T}p>0 all but at most N items j ∉ Ω}.

As in the previous section, this region is contained within the latent space, which is generally of relatively small dimension. However, its description depends on the number of items, which will generally be quite large. In the case of N=1, this dependence is linear and therefore manageable. For N>1, the item region is the union over polytopic cones for subsets describing “all but at most N items.” Therefore, the description of each item region requires [symbol] (m^{N}) linear inequalities. For systems with tens of thousands of items, even considering N=5 becomes prohibitively expensive.

To ease the notational burden of discussing the ranking logic around top-N selection in what follows, the operator max^{(N)} is defined, which selects the Nth largest value from a set. As used herein, for example,

$${\hat{r}}_{ui} > {\hat{r}}_{uj} all but at most N items j ⇔ {\hat{r}}_{ui} > {{max}^{( N )}}_{j \neq i} {\hat{r}}_{uj} .$$

Sufficient Condition for Availability; To avoid computational challenges, an algorithm may us sufficient condition for item availability. The full description of the region [symbol] ᵢ is not necessary to verify non-emptiness; rather, showing the existence of any point in the latent space v ∈ [symbol] ^{d} that satisfies v ∈ [symbol] ᵢ is sufficient. Using this insight, a processor may be configured with a sampling approach to determining the availability of an item. For a fixed v and any N, it is necessary only to compute and sort Q_{Ω}_{^{⊂}}v, which is an operation of complexity [symbol] (m²d log(m)). A processor may use the sample point v ∈ qᵢ. In an alternative, or in addition, a processor's sampling approach may make use of gridding, randomness, or empirical user factor(s).

Example Result 4: The item-region [symbol] ᵢ is nonempty if

$${δ}_{i} = {‖ {q}_{i} ‖}_{2}^{2} - {{max}^{( N )}}_{j ∉ Ω ⋂ \{ i \}} {q}_{j}^{⊤} {q}_{i} > 0. \qquad ( 5 )$$

When this condition holds, we say that item i is “aligned-reachable.” The proportion (e.g., percentage) of items that are aligned-reachable is a lower bound on the availability of items. The condition of being aligned-reachable is sufficient, but not necessary, for availability. For example, it is possible to have qᵢ ∉ [symbol] ᵢ for a nonempty [symbol] ᵢ. FIG. 5A illustrates one such example, wherein the latent factor region 514 lies partly within the larger region 514 even though the region 514 is non-empty. Accordingly, aligned-reachability yields an underestimate of the availability of items in a system.

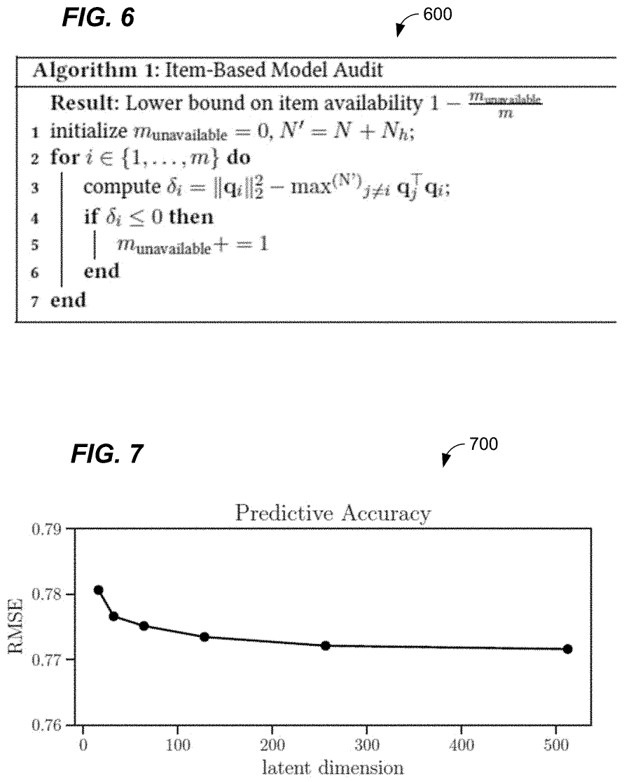

Recommender Model Auditing. As noted above, in connection with FIG. 4, a processor evaluates (audits) a recommender for user recourse and item availability. To use the aligned-reachable condition of Eq. (5) as a generic model audit, a processor may be programmed to sidestep the specificity of the set of seen items Ω. A processor may perform an audit based on the aligned-reachable condition with Ω=0 and an increased value for N, where increasing N compensates for discarding the effect of the items which have been seen, This audit is described by Algorithm 1 600, shown in FIG. 6. By setting N′=N+Nₕ where N is the number of items recommended by the system, then item availability has the following interpretation: if an item is not top-N′ available, then that item will not be recommended to a user who has seen fewer than Nₕ items.

If the set of all possible users are treated as users with a history of at most Nb, this model audit counts the number of aligned-unreachable items, returning a lower bound on the overall availability of items, A processor or human operator may further use this model audit to propose constraints or penalties on the recommender model during training.

Ensuring aligned-reachability is equivalent to imposing linear constraints on the matrix A=QQ^{T},

$${A}_{ii} \geq {{max}^{( N )}}_{j \neq i} {A}_{ij} .$$

While this constraint is not convex, relaxed versions of it could be incorporated into the optimization problem (2) to ensure reachability during training.

Sufficient Condition for Recourse. User recourse inherits the computational problems described above for N>1. We note that the region [symbol] ᵢ is not necessarily convex, though it is the union of convex regions. While the problem could be solved by first minimizing within each region and then choosing the minimum value over all regions, this would not be practical for large values of N. The sampling perspective may be continued to develop an efficient sufficient condition for verifying the feasibility of (4). A processor may test feasibility using the condition

$${v}_{0} + {Ba}_{j} ∈ {𝒫}_{i} for {a}_{i} ∈ arg {min}_{{ℛ}^{k}} {‖ Ba + {v}_{0} - {q}_{i} ‖}_{2}^{2} . \qquad ( 6 )$$

By checking feasibility for each i, we verify a lower bound on the amount of recourse available to a user, considering their specific rating history and the allowable actions.

If the control matrix B is full rank, then we can find a point aᵢ such that v₀+Baᵢ=qᵢ, meaning that items that are aligned-reachable are also reachable by users. The rank of B is equal to the rank of Q_{Ω}_{ₘ}, so as previously observed, item availability implies recourse for any user with control over at least d ratings whose corresponding item factors are linearly independent.

Even users with incomplete control have some level of recourse. For the following result, Π_{B} may be defined as the projection matrix onto the subspace spanned by B. Then let q_{B,i}=Π_{Bq}_{ᵢ} be the component of the target item factor that lies in the space spanned by the control matrix B, and v_{⊥}=v₀−Π_{Bv}_{₀} be the component of the anchor point that cannot be affected by user control.

Example Result 5: When [symbol] = [symbol] , a lower bound on the amount of recourse for a user u is given by a portion (e.g., percentage) of unseen items that satisfy the relation:

$${‖ {q}_{B , i} ‖}_{2}^{2} + {q}_{i}^{⊤} {v}_{⊥} > {{max}^{( N )}}_{j \neq i} ( {q}_{j}^{⊤} {q}_{B , i} + {q}_{j}^{⊤} {v}_{⊥} ) .$$

This relation mirrors the sufficient condition for items, with modifications relating both to the directions of user control and the anchor point. In short, user recourse follows from the ability to modify ratings for a set of diverse items, and immutable ratings ensure the reachability of some items, potentially at the expense of others,

Experimental Demonstrations. The analyses methods herein may be used as a tool to audit and interpret characteristics of a matrix factorization model. As a demonstration, the MovieLens 10M dataset, which comes from an online movie recommender service called MovieLens. The dataset (https://grouplens.org/datasets/movielens/10m/ contains approximately 10 million ratings applied to 10,681 movies by 71,567 users. The ratings fall between 0 and 5 in 0:5 increments. Movielens is a common benchmark for evaluating rating predictions.

Using the method described by Rendle et al. in their recent work on baselines for recommender systems (Steven Rendle, Li Zhang, and Yehuda Koren. On the difficulty of evaluating baselines: A study on recommender systems. arXiv preprint arXiv:1905.01395, 2019), we trained a regularized matrix factorization model. This model incorporates item, user, and overall bias terms. Appendix A of the Reachability Paper includes full description of adapting our proposed audits to this model.

Models of a variety of latent dimension ranging from d=16 to d=512 were examined. The models were trained using the libfm3 library disclosed by Steven Rendle in “Factorization machines with libFM,” ACM Trans. Intell. Syst. Technol., 3(3):57:1-57:22, May 2012. ISSN 2157-6904). We used the regression objective and optimized using SGD with regularization parameter λ=0:04 and step size 0:003 for 128 epochs on 90% of the data, verifying accuracy on the remaining 10% with a random global test/train split. These methods matched those presented by Rendle et al. noted above and reproduced their reported accuracies. FIG. 7 is a chart 500 showing a test root mean square error (RMSE) of the matrix factorization models on the MovieLens dataset for this demonstration. The error rate is stable within a narrow band over the dataset.

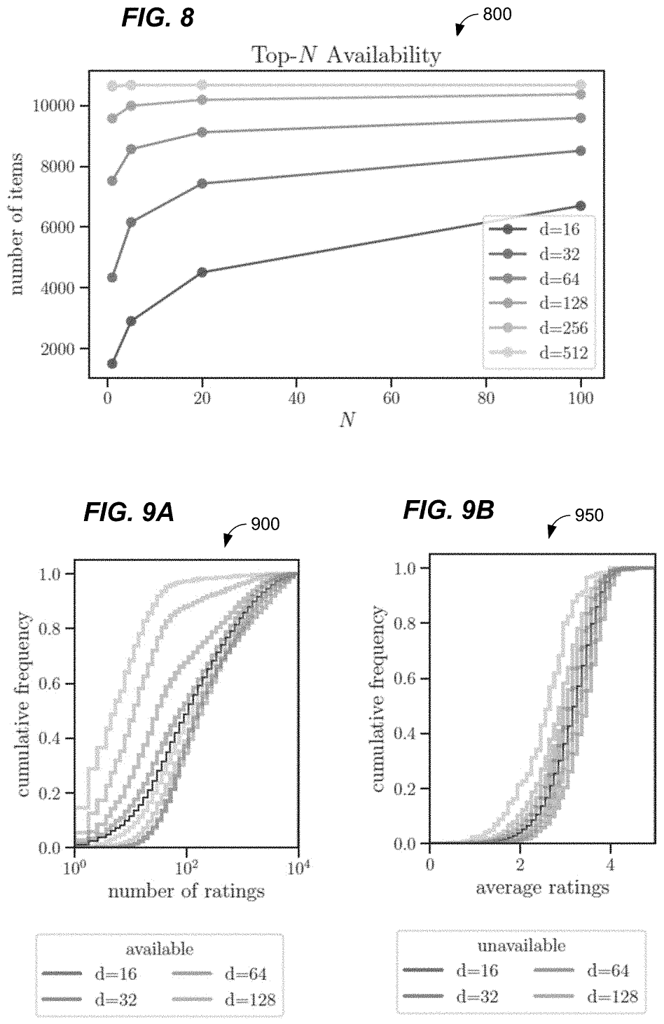

Item-based audit: We performed an item-based audit as described in in connection with FIG. 6. The chart 800 of FIG. 8 displays the total number of aligned-reachable movies for various parameters N. It is immediately clear that all items are baseline-reachable in only the models with the largest latent dimension. Indeed, the model with d=16 has only about 60% availability for users with a history of under 100 movies. On the other hand, the models with the highest complexity d ∈ {256,512} have about 99% availability for even the smallest values of N. Only some of the 10,681 total movies are aligned-reachable, especially for models with smaller complexity and for smaller recommendation set sizes N.

Characteristics of the items that are unavailable compared with those that are available were also examined. We examined two notions of popularity: total number of ratings (chart 900, FIG. 9A) and average rating (chart 950, FIG. 9B). FIGS. 9A-9B compare the distributions of the available and unavailable items (for N=5) in the training set on these measures. Unavailable items are systematically less popular than available items: they are rated less frequently and have lower average ratings in the training data. Each curve represents the cumulative density function (CDF) of the popularity measure within the available items (lower 4 lines) and unavailable items (upper 4 lines). The dividing line represents the CDF of the combined population. The illustrated trends are true for models of varying complexity.

FIGS. 9A-B show the unavailable items have systematically lower popularity for various latent dimensions. This observation has implications for the outcome of putting these models in feedback with users. If unavailable items are never recommended, they will be less likely to be rated, which may exacerbate their unavailability if models are updated online.

While the difference in popularity is true across all models, there is still overlap in the support of both distributions. For a given number of ratings or average rating, some items will be available while others will not, meaning that popularity alone does not determine reachability.

System Recourse for Users: The combined testing and training data was used to determine user ratings rᵤ and histories Ωᵤ. For this section, we examined 100 randomly selected users and only the 10700 most-rated items. Sub-selecting items and especially choosing them based on popularity means that these experimental results provide an overestimation of the amount of recourse available to users. Additionally, we allow ratings on the continuous interval [symbol] =[0,5] rather than enforcing integer constraints, meaning that our results represent the recourse available to users if they were able to precisely rate items on a continuous scale. Despite these two approximations, several interesting trends on the limits of recourse appear.

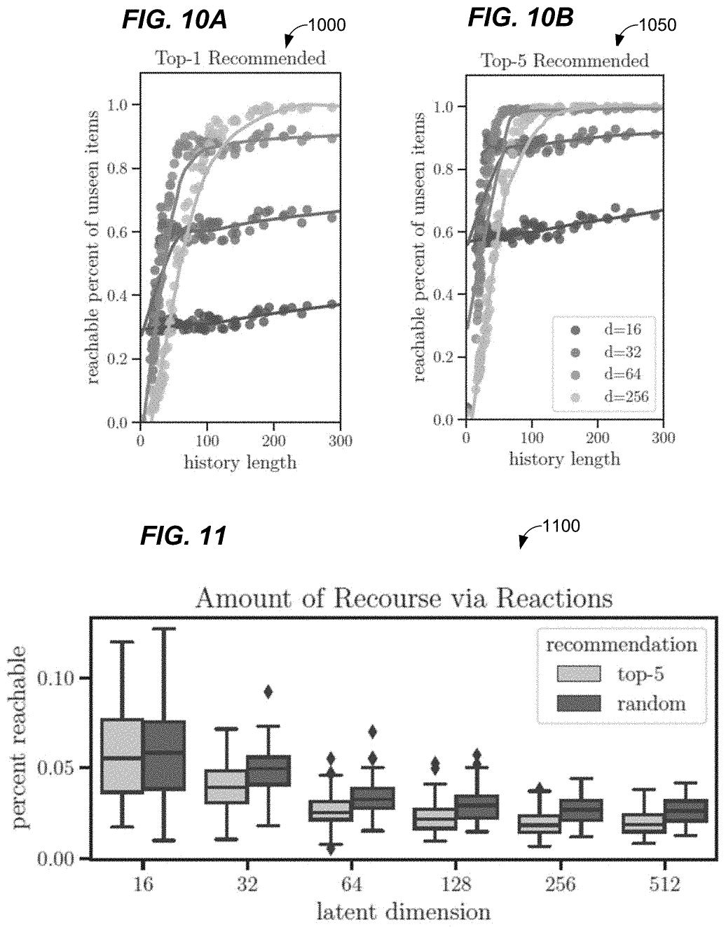

We begin with history edits and compute the amount of recourse that the system provides to users using the sufficient condition in Example Result 5. FIGS. 10A-10B show relationships between lengths of user history for several different latent dimensions. Chart 1000 relates to Top-1 recommendations, and chart 1050 to Top-5 recommendations. The proportion of unseen items reachable by users varies with their history length. A LOESS regressed curve illustrates the trend. Less complex models are better for shorter history lengths, while more complex models reach higher overall values. This is reflected in the shape of the curves: a fast increase and then leveling off for each dimension I. For short histories, we see the limiting effect of projection onto the control matrix Π_{B} For longer histories, as the rank of Q_{Ω}_{ᵤ} approaches or exceeds d, the baseline item-reachability determines the effect. The transition between these two regimes differs depending on the latent dimension of the model. Smaller models reach their maximum quickly, while models of higher complexity provide a larger amount of recourse to users with long histories. This is an interesting distinction that connects to the idea of “power users.”

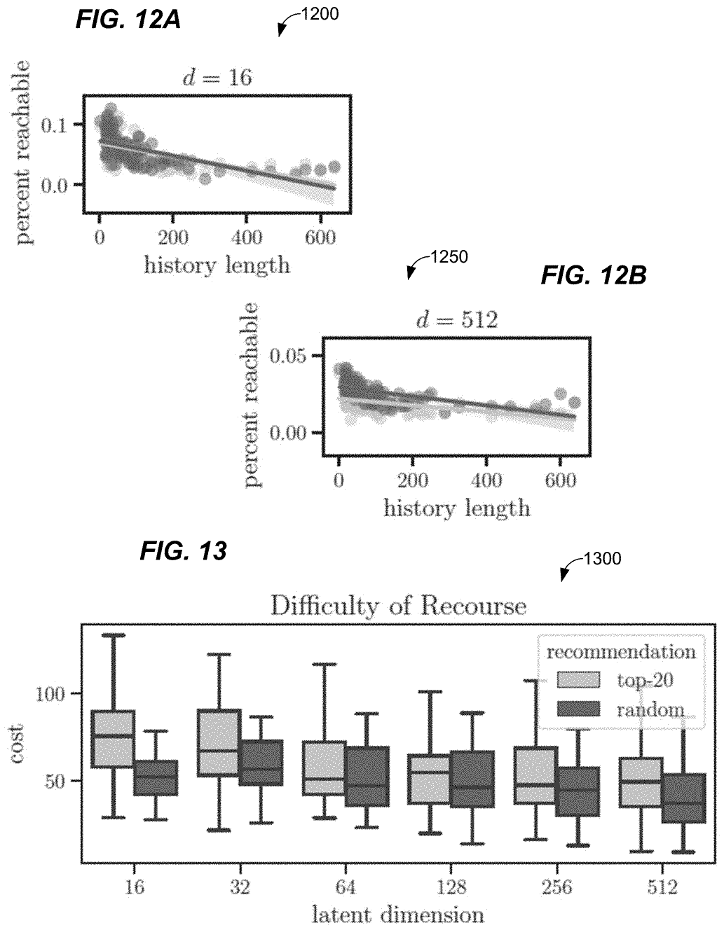

Reactions were considered where user input comes only through reaction to a new set of items while the existing ratings are fixed. FIGS. 11, 12A and 12B display the amount of recourse for two different types of new items: first, the case that users are shown a completely random set of 5 unseen items and second, the case that they are shown the 5 items with the highest predicted ratings. The panel 1100 displays the amount of recourse provided by each model and each type of recommendation. There are two important trends. First, smaller models offer larger amounts of recourse, because smaller models are in the regime of few mutable ratings, analogous to the availability of items to users with short histories in the previous figure. Second, for each model size, the random recommendations provide more recourse than the top-5, and though the gap is not large it is consistent.

In the panels 1200, 1250 of FIGS. 12A and 12B, we further examine how the length of user history interacts with this model of user behavior. For both the smallest latent dimensions (chart 1200) and the largest latent dimensions (chart 1250), there is a downwards trend between reachability and history length. This does not contradict the trend displayed in FIG. 11: in the reactions setting, the rating history manifests as the anchor point v₀ rather than additional degrees of freedom in the control matrix B. When actions are constrained to reaction to a set of items, lower complexity models provide higher reachability. A random set of items provides slightly more recourse to users than if the set is selected based on predicted user preferences. Furthermore, there is a slight trend that users with smaller history lengths have more available recourse.

Finally, we investigate the difficulty of recourse over all users and a single item. In this case, we consider top-1 recommendations to reduce the computational burden of computing the exact set [symbol] ᵢ. Cost is posed as the size of the difference between the user input ‘a’ and the predicted ratings in the λ₁ norm. Chart 1300 of FIG. 13 shows the difficulty of recourse via reaction for the two types of new items: a completely random set of 20 unseen items and 20 items with the highest predicted ratings. Two interesting trends are evident. First, the difficulty of recourse does not increase with model size (even though the amount of recourse is lower). Second, difficulty is lower for the random set of items than for the top-20 items. Along with the trend in availability, this suggests a benefit of suggesting items to users based on metrics other than predicted rating. It may be beneficial to construct recommender systems that trade off predicted ratings with measures like diversity under the lens of user recourse, to improve recourse.

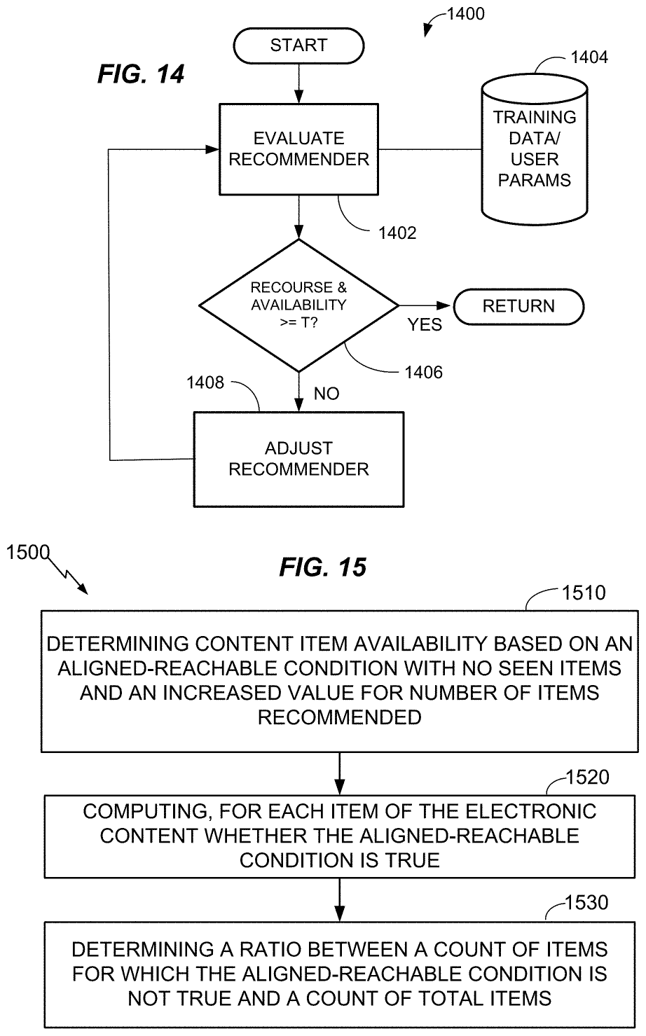

In accordance with the foregoing, and by way of additional example, FIG. 14 shows more general aspects of a method or methods 1400 according to one embodiment, as may be performed by a server with a recommender module as described herein. It should be appreciated that the more general operations of method 1400 may include or embody more detailed aspects of corresponding methods described herein above.

Referring to FIG. 14, a computer-implemented method 1400 for evaluating and revising a recommender module may include, at 1402, executing any of the auditing methods described herein above by a processor with access to the recommender's algorithm. In the evaluation 1402, the processor may access training data and user parameters in a computer database 1404. At 1406, the processor may compare recourse and availability of the recommender module, or equivalent parameters, to a targeted metric, If the metric is satisfied, the method 1400 may terminate. If the metric is not satisfied, the processor may at 1408 adjust the recommender module, for example by increasing or decreasing the dimension of the recommender or changing any other recommender parameter that affects the relevant metric as described herein, and reevaluate the amended recommender at 1402.

The method 1400, or the method 400 described in connection with FIG. 4, may include any one or more additional operations as described above and below herein. Each of these additional operations is not necessarily performed in every embodiment of the method, and the presence of any one of the operations does not necessarily require that any other of these additional operations also be performed.

For example, as shown in FIG. 15, optionally, the evaluating in methods 400, 1400 may further include at 1510, determining content item availability based on an aligned-reachable condition with no seen items and an increased value for number of items recommended, as further described in connection with Example Result 4 and Equation 5. The evaluating in methods 400, 1400 may further include at 1520, computing, for each item of the electronic content whether the aligned-reachable condition is true as shown, for example as shown in FIG. 6. The evaluating in methods 400, 1400 may further include at 1530, determining a ratio between a count of items for which the aligned-reachable condition is not true and a count of total items, as further shown in FIG. 6.

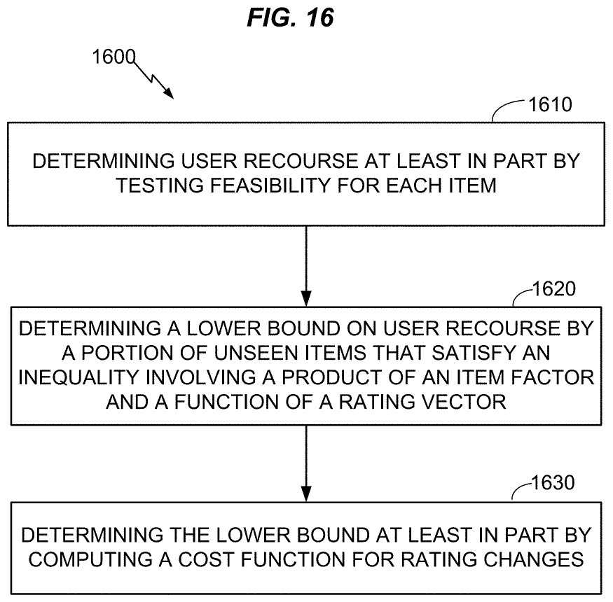

For example, as shown in FIG. 16, optionally, the evaluating in methods 400, 1400 may further include at 1610, determining user recourse at least in part by testing feasibility for each item, as described in connection with Equation (6). In an alternative, or in addition, the evaluating in methods 400, 1400 may include at 1620 determining a lower bound on user recourse by a portion of unseen items that satisfy an inequality involving a product of an item factor and a function of a rating vector, as described in connection with Example Result 5. In an alternative, or in addition, determining the lower bound may include, at 1630, computing a cost function for rating changes, as described in connection with Equation (4).

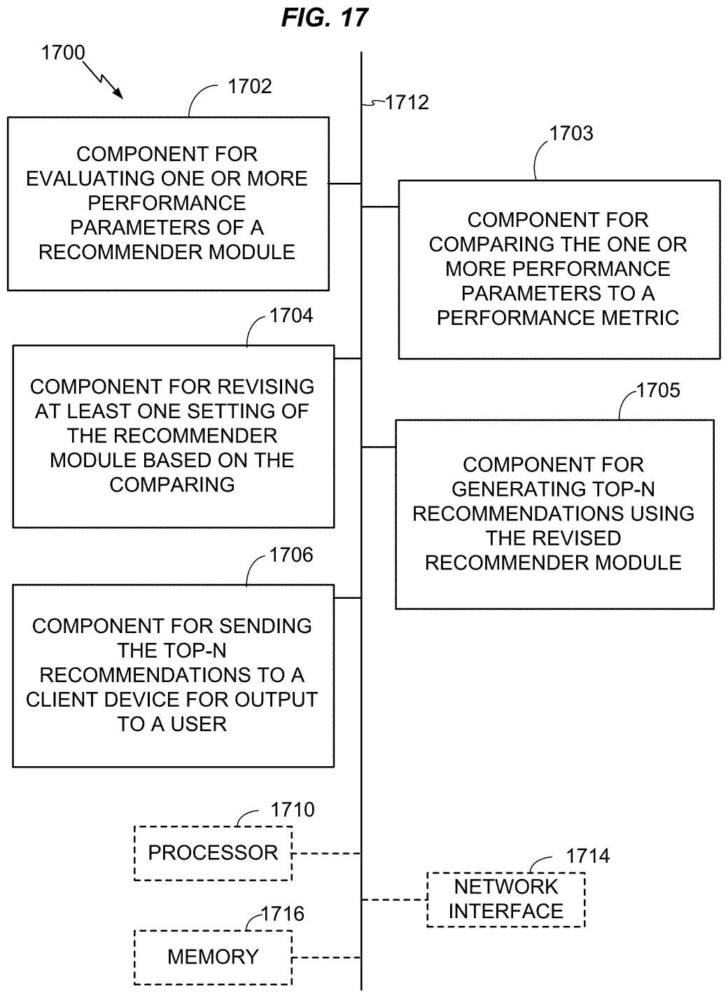

FIG. 17 is a conceptual block diagram illustrating components of an apparatus or system 1700 for providing a user interface of a computing device enabling selection of and access to items of electronic content in an online library, according to one embodiment. As depicted, the apparatus or system 1700 may include functional blocks that can represent functions implemented by a processor, software, or combination thereof (e.g., firmware).

As illustrated in FIG. 17, the apparatus or system 1700 may comprise an electrical component 1702 for evaluating one or more performance parameters of a recommender module that provides top-N recommendations based on user factors and content factors for an online library. The component 1702 may be, or may include, a means for said evaluating. Said means may include the processor 1710 coupled to the memory 1716, the processor executing an algorithm based on program instructions stored in the memory. Such algorithm may include a sequence of more detailed operations, for example, any of the specific algorithms for evaluating user recourse or item availability as described herein above.

The apparatus or system 1700 may further comprise an electrical component 1703 for comparing the one or more performance parameters to a performance metric. The component 1703 may be, or may include, a means for said comparing. Said means may include the processor 1710 coupled to the memory 1716, the processor executing an algorithm based on program instructions stored in the memory. Such algorithm may include a sequence of more detailed operations, for example, retrieving a target metric from a computer memory, determining whether the target metric is larger or smaller than the evaluated metric, and setting the value of at least one bit based on the relative values of the compared metrics.

The apparatus or system 1700 may further comprise an electrical component 1704 for revising at least one setting of the recommender module based on the comparing. The component 1704 may be, or may include, a means for said revising. Said means may include the processor 1710 coupled to the memory 1716, the processor executing an algorithm based on program instructions stored in the memory. Such algorithm may include a sequence of more detailed operations, for example, deciding, based on an output of the deciding, which of at least two different variables of the recommender module to change, deciding how much to change the selected variable based on the output, and changing the value of the selected variable in a memory of the recommender module. These operations may be repeated for additional variables.

As illustrated in FIG. 17, the apparatus or system 1700 may comprise an electrical component 1705 for generating top-N recommendations using the recommender module as revised by the revising. The component 1705 may be, or may include, a means for said generating. Said means may include the processor 1710 coupled to the memory 1716, the processor executing an algorithm based on program instructions stored in the memory. Such algorithm may include a sequence of more detailed operations, for example, selecting ‘N’ items to recommend based on user factors and content factors, using a matrix factorization method as described herein.

As illustrated in FIG. 17, the apparatus or system 1700 may comprise an electrical component 1706 for sending the top-N recommendations to a client device for output to a user. The component 1706 may be, or may include, a means for said sending. Said means may include the processor 1710 coupled to the memory 1716, and to the network interface 1714, the processor executing an algorithm based on program instructions stored in the memory. Such algorithm may include a sequence of more detailed operations, for example, sending the top-N recommendations with a destination address from an application layer of the recommender module to a transport layer of the network interface, which formats the information for the interface and transmits it to the destination address by the applicable network protocol.

The apparatus 1700 may optionally include a processor module 1710 having at least one processor, in the case of the apparatus 1700 configured as a data processor. The processor 1710, in such case, may be in operative communication with the modules 1702-1706 via a bus 1712 or other communication coupling, for example, a network. The processor 1710 may effect initiation and scheduling of the processes or functions performed by electrical components 1702-1706.

In related aspects, the apparatus 1700 may include a network interface module 1714 operable for communicating with a storage device over a computer network. In further related aspects, the apparatus 1700 may optionally include a module for storing information, such as, for example, a memory device/module 1716. The computer readable medium or the memory module 1716 may be operatively coupled to the other components of the apparatus 1700 via the bus 1712 or the like. The memory module 1716 may be adapted to store computer readable instructions and data for effecting the processes and behavior of the modules 1702-1706, and subcomponents thereof, or the processor 1710, or the method 400 or 1400 and one or more of the additional operations 1500, 1600 described in connection with these methods, or any one or more of the algorithms and equations described herein in symbolic form. The memory module 1716 may retain instructions for executing functions associated with the modules 1702-1706. While shown as being external to the memory 1716, it is to be understood that the modules 1702-1706 can exist within the memory 1716.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer or system of cooperating computers. By way of illustration, both an application running on a server and the server can be a component. One or more components may reside within a process and/or thread of execution and a component may be localized on one computer and/or distributed between two or more computers.

Program instructions may be written in any suitable high-level language, for example, C, C++, C#, JavaScript, or Java™, and compiled to produce machine-language code for execution by the processor. Program instructions may be grouped into functional modules, to facilitate coding efficiency and comprehensibility. It should be appreciated that such modules, even if discernable as divisions or grouping in source code, are not necessarily distinguishable as separate code blocks in machine-level coding, Code bundles directed toward a specific function may be considered to comprise a module, regardless of whether machine code on the bundle can be executed independently of other machine code. In other words, the modules may be high-level modules only.

Various aspects will be presented in terms of systems that may include several components, modules, and the like, It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. As used herein, a “processor” encompasses any one or functional combination of the foregoing examples.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

The previous description of the disclosed aspects is provided to enable any person skilled in the art to make or use the present disclosure. Various modifications to these aspects will be clear to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method for providing a user interface of a computing device enabling selection of and access to items of electronic content in an online library, the method comprising:
evaluating, by at least one processor, one or more performance parameters of a recommender module that provides top-N recommendations based on user factors and content factors for an online library;
comparing, by the at least one processor, the one or more performance parameters to a performance metric;
revising, by the at least one processor, at least one setting of the recommender module based on the comparing;
generating, by the at least one processor, top-N recommendations using the recommender module as revised by the revising; and
sending, by the at least one processor, the top-N recommendations to a client device for output to a user.

2. The method of claim 1, wherein the recommender module uses matrix factorization.

3. The method of claim 1, wherein the evaluating further comprises determining the performance parameters including at least one of user recourse and content item availability.

4. The method of claim 3, wherein the evaluating further comprises determining content item availability based on an aligned-reachable condition with no seen items and an increased value for number of items recommended.

5. The method of claim 4, wherein determining item availability comprises computing, for each item of the electronic content whether the aligned-reachable condition is true.

6. The method of claim 5, wherein determining the item availability further comprises determining a ratio between a count of items for which the aligned-reachable condition is not true and a count of total items.

7. The method of claim 3, wherein the evaluating further comprises determining user recourse at least in part by testing feasibility for each item.

8. The method of claim 3, wherein the evaluating further comprises determining a lower bound on user recourse by a portion of unseen items that satisfy an inequality involving a product of an item factor and a function of a rating vector.

9. The method of claim 8, wherein determining the lower bound comprises computing a cost function for rating changes.

10. An apparatus for providing a user interface of a computing device enabling selection of and access to items of electronic content in an online library, comprising at least one processor coupled to a memory holding program instructions that when executed by the at least one processor, cause the apparatus to perform:
evaluating one or more performance parameters of a recommender module that provides top-N recommendations based on user factors and content factors for an online library;
comparing the one or more performance parameters to a performance metric;
revising at least one setting of the recommender module based on the comparing;
generating top-N recommendations using the recommender module as revised by the revising; and
sending the top-N recommendations to a client device for output to a user.

11. The apparatus of claim 10, wherein memory holds further instructions for matrix factorization in the recommender module.

12. The apparatus of claim 10, wherein memory holds further instructions for the evaluating at least in part by determining the performance parameters including at least one of user recourse and content item availability.

13. The apparatus of claim 12, wherein memory holds further instructions for the evaluating at least in part by determining content item availability based on an aligned-reachable condition with no seen items and an increased value for number of items recommended.

14. The apparatus of claim 13, wherein memory holds further instructions for the determining item availability at least in part by computing, for each item of the electronic content whether the aligned-reachable condition is true.

15. The apparatus of claim 14, wherein memory holds further instructions for the determining the item availability at least in part by determining a ratio between a count of items for which the aligned-reachable condition is not true and a count of total items.

16. The apparatus of claim 12, wherein memory holds further instructions for the evaluating at least in part by determining user recourse by testing feasibility for each item.

17. The apparatus of claim 12, wherein memory holds further instructions for the evaluating at least in part by determining a lower bound on user recourse by a portion of unseen items that satisfy an inequality involving a product of an item factor and a function of a rating vector.

18. The apparatus of claim 17, wherein memory holds further instructions for the evaluating at least in part by determining the lower bound by computing a cost function for rating changes.

19. The apparatus of claim 10, further comprising a network interface for sending the top-N recommendations to the client device.

20. An apparatus for providing a user interface of a computing device enabling selection of and access to items of electronic content in an online library, comprising:
means for evaluating one or more performance parameters of a recommender module that provides top-N recommendations based on user factors and content factors for an online library;
means for comparing the one or more performance parameters to a performance metric;
means for revising at least one setting of the recommender module based on the comparing;
means for generating top-N recommendations using the recommender module as revised by the revising; and
means for sending the top-N recommendations to a client device for output to a user.
